(19) United States
(12) Patent Application Publication
(10) Pub. No.: US 2024/0362275 A1
(43) Pub. Date: Oct. 31, 2024

(54) METHOD AND DEVICE FOR INFORMATION PROCESSING

(71) Applicant: NEC CORPORATION, Tokyo (JP)

(72) Inventors: Zhongjie WEI, Beijing (CN); Lu FENG, Beijing (CN)

(73) Assignee: NEC CORPORATION, Tokyo (JP)

(21) Appl. No.: 18/600,111

(22) Filed: Mar. 8, 2024

(30) Foreign Application Priority Data
Apr. 26, 2023 (CN) 2023104670961

(51) Int. Cl. G06F 16/93; G06F 16/901; G06F 16/904

(52) U.S. Cl. CPC G06F 16/93; G06F 16/9024; G06F 16/904

(57) ABSTRACT

According to embodiments of the disclosure, a method and an apparatus for information processing are provided. The method includes determining a plurality of pending events from one or more media contents, at least two of the plurality of pending events having an event relationship. The method further includes determining an additional event set from the plurality of pending events based on an existing event set for constructing an event evolutionary graph, an additional event in the additional event set being different from an existing event in the existing event set. The method further includes updating the event evolutionary graph based on the additional event set. In this way, incremental updates of the event evolutionary graph can be realized, thereby improving the construction efficiency of the event evolutionary graph.

### CROSS-REFERENCE

This application claims the benefit of Chinese Patent Application No. 202310467096.1, filed on Apr. 26, 2023, entitled “METHOD AND DEVICE FOR INFORMATION PROCESSING”, the entirety of which is hereby incorporated herein by reference.

### FIELD

Example embodiments of the present disclosure generally relate to the field of computers, and more particularly to, a method and a device for information processing.

### BACKGROUND

With the development of network technology and multimedia technology, the number of news is increasing exponentially every day. Events may be extracted from news, and a relationship between different events may be represented using an event evolutionary graph. As the number of news increases every day, the number of extracted events also increases. Therefore, it is necessary to update the event evolutionary graph accordingly. Using newly obtained news and historical news to construct the event evolutionary graph from scratch whenever new news is obtained results in very low efficiency. The construction of the event evolutionary graph is a relatively complex process. As the amount of data involved in the construction increases, the difficulty of constructing the event evolutionary graph also increases significantly. Therefore, a solution that can efficiently construct the event evolutionary graph is desired.

### SUMMARY

In a first aspect of the present disclosure, a method of information processing is provided. The method includes: determining a plurality of pending events from one or more media contents, at least two of the plurality of pending events having an event relationship; determining an additional event set from the plurality of pending events based on an existing event set for constructing an event evolutionary graph, an additional event in the additional event set being different from an existing event in the existing event set; and updating the event evolutionary graph based on the additional event set.

In a second aspect of the present disclosure, an electronic device is provided. The electronic device includes at least one processing circuit. The at least one processing circuit is configured to: determine a plurality of pending events from one or more media contents, at least two of the plurality of pending events having an event relationship; determine an additional event set from the plurality of pending events based on an existing event set for constructing an event evolutionary graph, an additional event in the additional event set being different from an existing event in the existing event set; and update the event evolutionary graph based on the additional event set.

In some embodiments of the second aspect, the at least one processing circuit is further configured to: determine, for a given event of the plurality of pending events, respective matching degrees between a text describing the given event and texts describing respective existing events in the existing event set; and in response to the respective matching degrees being less than a threshold matching degree, identify the given event as an additional event.

In some embodiments of the second aspect, the at least one processing circuit is further configured to: add, in a document database for the event evolutionary graph, an entry corresponding to the given event for storing information related to the given event; and set an additional event field in the entry as a predetermined value representing additional events.

In some embodiments of the second aspect, the at least one processing circuit is further configured to: in response to the update of the event evolutionary graph, cancel the identification of the given event as the additional event.

In some embodiments of the second aspect, the at least one processing circuit is further configured to: in response to the matching degree between the text describing the given event and a text describing a first existing event exceeding the threshold matching degree, store, in an entry in the document database corresponding to the first existing event, information related to a target media content in the one or more media contents, wherein the given event is determined from the target media content.

In some embodiments of the second aspect, the at least one processing circuit is further configured to: determine, for a first additional event in the additional event set, a first text element in a text describing the first additional event; update element occurrence frequency information corresponding to the first text element stored in a key-value database; determine a second existing event in the existing event set, wherein a text describing the second existing event comprises the first text element; and update, in the event evolutionary graph, an association degree of an event relationship between the second existing event and a third existing event based on the updated element occurrence frequency information.

In some embodiments of the second aspect, the at least one processing circuit is further configured to: determine, from the existing event set or the additional event set, a first event having an event relationship with the first additional event, and a second text element in a text describing the first event; update element pair occurrence frequency information stored in the key-value database, the element pair occurrence frequency information indicating that the first text element occurs in association with the second text element; and in response to a text describing the third existing event comprising the second text element, update the association degree further based on the updated element pair occurrence frequency information.

In some embodiments of the second aspect, the at least one processing circuit is further configured to: determine, for a second additional event in the additional event set, a similarity between the second additional event and a second event in the additional event set or the existing event set; and in response to the similarity exceeding a threshold similarity, store, in a document database for the event evolutionary graph, an indication of a similarity relationship between the second additional event and the second event.

In some embodiments of the second aspect, the at least one processing circuit is further configured to: determine an abstract event for generalizing the second additional event and at least the second event having the similarity relationship to the second additional event; correspond, in the event evolutionary graph, the second additional event and the second event to the abstract event; and add a node representing the abstract event to a visual representation of the event evolutionary graph.

In a third aspect of the present disclosure, an electronic device is provided. The device comprises at least one processing unit; and at least one memory, the at least one memory is coupled to the at least one processing unit and stores an instruction for execution by the at least one processing unit. The instruction causes the device to perform the method of the first aspect when executed by the at least one processing unit.

In a fourth aspect of the present disclosure, a computer-readable storage medium is provided. The computer-readable storage medium stores a computer program that can be executed by a processor to implement the method of the first aspect.

It should be understood that the contents described in the content section of the present invention are not intended to limit the key features or important features of the embodiments of the present disclosure, nor are they intended to limit the scope of the present disclosure. Other features of the present disclosure will become readily understood from the following description.

### BRIEF DESCRIPTION OF THE DRAWINGS

The above and other features, advantages and aspects of the various embodiments of the present disclosure will become more apparent in combination with the accompanying drawings and with reference to the following detailed description. In the drawings, same or similar reference numerals denote same or similar elements.

FIG. 1 shows a schematic diagram of an example environment in which embodiments of the present disclosure can be implemented;

FIG. 2 shows a schematic diagram of an example architecture for information processing according to some embodiments of the present disclosure;

FIG. 3 shows a schematic diagram of an event processing flow according to some embodiments of the present disclosure;

FIG. 4 shows a schematic diagram of runtime of an incrementally constructed event evolutionary graph according to some embodiments of the present disclosure;

FIG. 5 shows a flowchart of a process of information processing according to some embodiments of the present disclosure; and

FIG. 6 shows a block diagram of an electronic device capable of implementing multiple embodiments of the present disclosure.

### DETAILED DESCRIPTION

The following will describe embodiments of the present disclosure in more detail with reference to the accompanying drawings. Although certain embodiments of the present disclosure are shown in the drawings, it should be understood that the present disclosure can be implemented in various forms and should not be comprehended as limited to the embodiments set forth herein. On the contrary, these embodiments are provided for a more thorough and complete understanding of the present disclosure. It should be understood that the accompanying drawings and embodiments of the present disclosure are for illustrative purposes only and are not intended to limit the scope of protection of the present disclosure.

It should be noted that the titles of any section/sub-section provided in this article are not restrictive. Various embodiments are described throughout this disclosure, and any type of embodiment may be included under any section/sub-section. In addition, the embodiments described in any section/sub-section may be combined in any way with any other embodiments described in the same section/sub-section and/or different sections/sub-sections.

In the description of embodiments of the present disclosure, the term “comprising” and similar terms should be understood as open-ended inclusion, that is, “comprising but not limited to”. The term “based on” should be understood as “at least partially based on”. The term “one embodiment” or “the embodiment” should be understood as “at least one embodiment”. The term “some embodiments” should be understood as “at least some embodiments”. The following may also include other explicit and implicit definitions.

The term “circuit” as used herein may refer to hardware circuitry and/or a combination of hardware circuitry and software. For example, a circuit may be a combination of analog and/or digital hardware circuitry with software/firmware. As another example, a circuit may be any part of a hardware processor with software, and the hardware processor includes Digital Signal Processing(s), software, and a memory (or memories), which work together to enable the device to function to perform various functions. In yet another example, a circuit may be a hardware circuit and/or a processor, such as part of a microprocessor or a microprocessor, which requires software/firmware for operation, but may not exist when not required for operation. As used herein, the term “circuit” also encompasses only hardware circuitry or processors or a portion of hardware circuitry or processors and its (or their) accompanying software and/or firmware implementations.

As used in this disclosure, the term “event” refers to an occurrence of certain behaviors or situations in which participants participate, or a change in an objective state. A text describing an event may contain multiple words to describe the occurrence of the event and a component of the event. In form, factors of an event may include a trigger word or type of the event, a main participant of the event, the time and place of the event, and/or the like.

As used herein, the term “incremental update” refers to only updating data that has changed, and not updating data that has not changed or has already been updated. This can save time required by update operations, thereby improving efficiency.

As used herein, the term “text” may refer to language with any length. As an example, a text may refer to one or more words, a phrase, a part of sentences, a sentence, etc.

The term “similar event pair” refers to events that have different descriptive texts but express the same semantics. For example, events “an increment of price” and “price increases” are similar event pairs.

As used herein, the term “word” may have any suitable granularity. For example, for one language, a “word” may include one or more characters. For another language, a “word” may be a single word composed of one or more characters.

### Example Environment

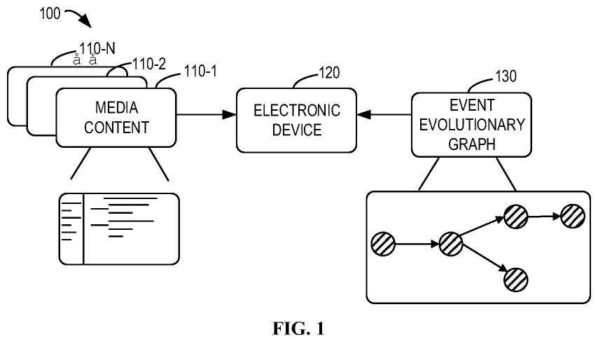

FIG. 1 shows a schematic diagram of an example environment 100 in which embodiments of the present disclosure can be implemented. In the environment 100, an electronic device 120 obtains one or more media contents 110-1, 110-2 . . . , 110-N, which are further collectively or individually referred to as a media content 110, where N is an integer greater than or equal to 1. The electronic device 120 may construct an event evolutionary graph 130 based on the media content 110.

In the environment 100, the electronic device 120 may be any type of device with computing capabilities, including a terminal device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a gaming device, or any combination thereof, including accessories and peripherals of these devices, or any combination thereof.

The media content 110 may be any suitable form of content that can provide information. For example, the media content 110 may be a news report in a form of a text, an image, audio, video, or any combination thereof. The media content 110 may be a news report of any sector, industry, or field, such as news in the financial sector. The media content 110 may be obtained from various platforms (for example, a news platform) or may be a stored media content. For the media content 120 in a form of text, the electronic device 120 may directly extract information for constructing an event evolutionary graph 130 from the text. For the media content 110 in the form of an image, video, audio, or the like, the electronic device 120 may extract information for constructing the event evolutionary graph 130 from the image, the audio, or the video using any known technology or technology developed in the future. For example, the electronic device 120 may directly extract related information from the image, the video, or the audio format based on image recognition or speech recognition technology.

The event evolutionary graph is an event evolutionary logic knowledge base that describes an evolutionary rule and pattern between events. The event evolutionary graph may be used to represent an event relationship between an event and a different event. For example, the event evolutionary graph may represent an event and an event relationship by using a logical directed graph. Such a logical directed graph takes events as nodes and event relationships as directed edges. The construction of the event evolutionary graph is a relatively complex process. For example, the construction process may include the following steps: event extraction, relationship extraction, event generalization, relationship strength computation, knowledge storage, or the like.

In this disclosure, the event relationship is also referred to as association or abbreviated as a relationship. Such an event relationship may include but is not limited to a causal relationship, a conditional relationship, a reversal relationship, a sequential relationship, a hierarchical relationship, a compositional relationship, a concurrent relationship, a similar relationship, and so on. As an example, the causal relationship refers to the occurrence of a preceding event (that is, the cause) leading to the occurrence of a subsequent event (that is, the result). The conditional relationship refers to the occurrence of a preceding event being a condition for the occurrence of a subsequent event. The reversal relationship refers to one event opposing another event, for example, where one event occurs later, but another event develops rapidly. The sequential relationship refers to the successive occurrence of a preceding event and a subsequent event in time. The hierarchical relationship refers to one event being a superior or subordinate event of another event, including both noun and verb hierarchies. For example, an event “rise in food prices” and an event “rise in vegetable prices” constitute a noun hierarchical relationship; an event “killing” and an event “assassinating” constitute a verb hierarchical relationship. The compositional relationship refers to one event being a component of another event. The concurrent relationship refers to one event occurring simultaneously with another event. The similar relationship refers to the similarity between one event and another event to a certain extent, for example, the similar relationship may be established through a similarity computation. The above event relationships are merely examples and are not intended to limit the scope of the present disclosure.

It should be understood that the structure and function of the environment 100 are only described for illustrative purposes, without implying any limitation on the scope of the present disclosure.

As briefly mentioned above, the construction of the event evolutionary graph is a cumbersome process with many intermediate results. In some scenarios, there are high time requirements for the event evolutionary graph. For example, a financial event evolutionary graph based on the causal relationship shows a causal relationship transmission chain between financial events, which may be used to predict a financial risk event in advance. Timeliness is crucial in predicting the financial risk event. When using the event evolutionary graph to predict a financial risk, it is only by timely integrating high timeliness financial events into the event evolutionary graph that risk events can be predicted more reasonably and accurately. Therefore, it is of great significance to construct the event evolutionary graphs with strong timeliness.

On the other hand, the number of media contents, such as news, is also increasing rapidly. If the graph construction process cannot be performed incrementally, then each update of the graph have to start from scratch by using new information and historical information together to reconstruct the graph. As the scale of the graph expands, the time for updating the graph will also become longer. This will lead to a low efficiency in constructing the event evolutionary graph.

In view of this, it is expected to update the event evolutionary graph incrementally. How to efficiently perform an incremental update on the event evolutionary graph is a valuable issue.

Therefore, embodiments of the present disclosure propose a solution for information processing. In this solution, a plurality of pending events are determined from one or more media contents, and at least two of the plurality of pending events have an event relationship. An additional event set is determined from the plurality of pending events based on an existing event set for constructing an event evolutionary graph. An additional event in the additional event set is different from an existing event in the existing event set. That is, the existing event is filtered out from these pending events, and a new event that is not considered in the current event evolutionary graph is obtained. Then, the event evolutionary graph is updated based on the additional event set.

Therefore, the event evolutionary graph is updated based on the additional event different from the existing event. In this way, the update of the event evolutionary graph may only use new events, so that an incremental update of the event evolutionary graph can be achieved. This may improve the efficiency of constructing the event evolutionary graph advantageously.

### An Architecture of an Update of the Event Evolutionary Graph

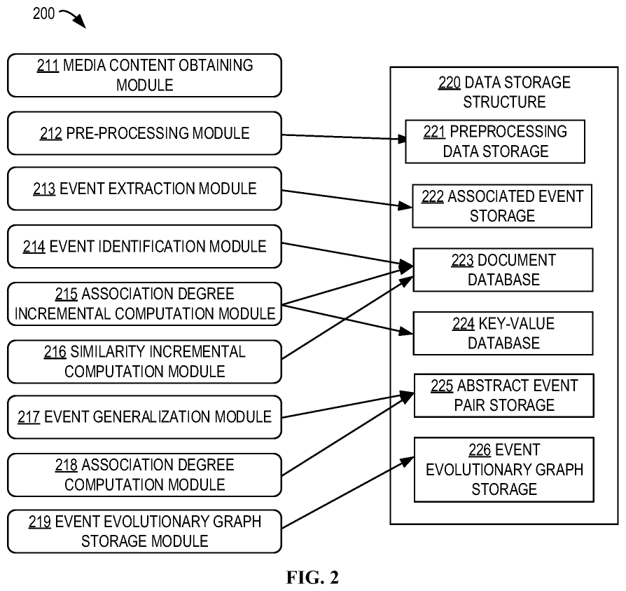

FIG. 2 shows a schematic diagram of an example architecture 200 for information processing in accordance with some embodiments of the present disclosure. The architecture 200 may include a media content obtaining module 211, a preprocessing module 212, an event extraction module 213, an event identification module 214, an association degree incremental computation module 215, a similarity incremental computation module 216, an event generalization module 217, an association degree computation module 218, and an event evolutionary graph storage module 219. The architecture 200 may further include a data storage structure 220, which may include a preprocessing data storage 221, an associated event storage 222, a document database 223, a key-value database 224, an abstract event pair storage 225, and an event evolutionary graph storage 226. These modules in the architecture 200 may be implemented in the electronic device 120.

In some embodiments, a plurality of events may be determined from one or more media contents 110, also referred to as a plurality of pending events. At least two of these pending events have an event relationship, that is, an association. An event pair having an association may be a combination of two events having logical relationships such as sequential, causal, conditional, or hierarchical relationships.

The following describes an example of the determination of pending events in combination of the media content obtaining module 211, the preprocessing module 212, and the event extraction module 213 in the architecture 200.

The media content obtaining module 211 may be configured to obtain one or more media contents 110. For example, the media content obtaining module 211 may obtain the media content 110 from various platforms, such as news platforms, or may obtain the stored media content 110 from any storage medium.

In some embodiments, the media content obtaining module 211 may utilize web crawling technology to obtain the media content 110 from the platform. The media content obtaining module 211 may obtain the media content from the platform at a set time or at any time, and may further obtain the media content from the platform in real time, to maintain the timeliness of the media content (for example, news data).

The preprocessing module 212 may be configured to preprocess the media content 110 obtained by the media content obtaining module 211. For example, the preprocessing of a news corpus may include, but is not limited to, paragraph segmentation, sentence segmentation, processing of punctuations, word segmentation, part-of-speech tagging, or other preprocessing methods. After the preprocessing is completed, the preprocessing module 212 may store the result obtained by preprocessing the media content 110 to the preprocessing data storage 221.

The event extraction module 213 may be configured to extract an event from the preprocessed media content. The extracted event is the pending event. For example, an event pair with an association may be extracted from the preprocessed media content. The event extraction module 213 may extract the event pair with the logical relationship such as a sequential, causal, conditional, and/or hierarchical relationship from the preprocessed media content.

In some embodiments, the event extraction module 213 may use a deep learning model to extract the event pair with the correlation from the preprocessed media content. The deep learning model may be trained using a corpus labeled with correlations of event pairs. Any suitable deep learning model algorithm may be employed. For example, any of the BERT model, a bidirectional long short-term memory (BiLSTM) network, or a conditional random field (CRF) model may be employed. In another example, a BERT_BILSTM_CRF model may be employed.

In some embodiments, the event extraction module 213 may store, to the associated event storage 222, the extracted events having an association.

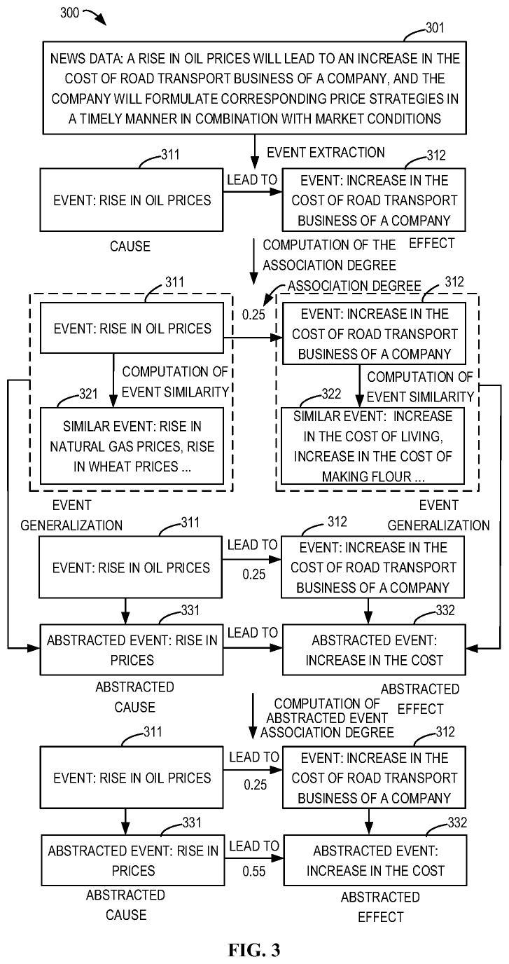

Referring to FIG. 3, an example of the determination of pending events is described. FIG. 3 shows a schematic diagram of an event processing flow 300 according to some embodiments of the present disclosure. As shown in FIG. 3, a media content 301 is “a rise in oil prices will lead to an increase in the cost of road transport business of a company, and the company will formulate corresponding price strategies in a timely manner in combination with market conditions”. By preprocessing and extracting events from the media content 301, an event pair with a correlation may be extracted from the media content 301, that is, a “rise in oil prices” event 311 and a “increase in the cost of road transport business of a company” event 312. Because “rise in oil prices” is a cause leading to the result “increase in the cost of road transport business of a company”, the two events “rise in oil prices” and “increase in the cost of road transport business of a company” are an event pair with an correlation. In other words, they are an event pair with a causal relationship.

Continuing with reference to FIG. 2, the event identification module 214 is configured to determine an additional event set from the plurality of pending events based on an existing event set for constructing an event evolutionary graph. An additional event in the additional event set is different from an existing event in the existing event set, and may also be referred to as a new event.

The existing event set may refer to a set of existing events that have been used for constructing the event evolutionary graph. In other words, existing events have been reflected in the event evolutionary graph. For example, existing events may be extracted from previous media contents that have been used to construct the event evolutionary graph. In contrast, the new event may refer to an event that has not yet been used to construct the event evolutionary graph, such as an event extracted from newly obtained media contents.

The event identification module 214 may utilize any suitable manner to compare pending events with existing events to identify an additional event in the pending events. In some embodiments, the event identification module 214 may determine, for any pending event (also referred to as a given event) of the plurality of pending events, respective matching degrees between a text describing the given event and texts describing respective existing events in the existing event set. If the respective matching degrees are less than a threshold matching degree, the given event may be identified as an additional event.

In some embodiments, the matching degree may be determined by comparing strings included in the text describing the given event with strings included in the text describing respective existing events. For example, if the number of identical characters included in the text describing the given event and the text describing a certain existing event in the existing event set is greater than or equal to a threshold number (or both of them include completely identical strings), then it can be determined that the matching degree of the text of the given event and the text of the existing event is relatively high. This means that the given event is not a new event for the event evolutionary graph. If the number of identical characters included in the text describing the given event and the texts describing each existing event in the existing event set are less than the threshold number (or the given event and any existing event do not include completely identical characters), then it can be determined that the matching degree of the text of the given event and all existing events in the existing event set are relatively low. This means that the given event is a new event for the event evolutionary graph.

In some embodiments, the event identification module 214 may assign a unique identifier (ID) to each extracted event (that is, each pending event). The ID may be a unique identifier for each event (including pending events, existing events). The event identification module 214 may store information related to the additional event in the document database 223 for the event evolutionary graph. The document database 223 may include but is not limited to MongoDB database, and of course, other document databases.

The document database 223 includes entries for storing information related to events. Each entry may be used to store information of a corresponding event, and the assigned event ID may be used as an index for the entry. The entry may include a field for identifying whether the corresponding event is an additional event, which is also known as an additional event field. In the construction process of the event evolutionary graph, due to the numerous attributes of the event and the complex data format involved, this disclosure adopts the document database 223 as a method for data storage. This method facilitates data addition, deletion, modification, and querying, and is conducive to incremental construction of the event evolutionary graph.

In some embodiments, if a certain given event is determined to be the additional event, the event identification module 214 may add, in the document database 223, an entry corresponding to the given event. The event identification module 214 may also set the additional event field in the entry as a predetermined value representing that the given event is the additional event. As an example, a field “new” may be added in the entry for identifying the corresponding event as the additional event.

After each round or batch of updates to the event evolutionary graph, the event identification module 214 may cancel the identification of the additional event. For example, the event identification module 214 may modify the additional event field of the entry of the additional event in the update round to a value representing that it is an existing event, or remove the additional event field from the entry.

In some embodiments, if the matching degree between the text describing the given event and a text describing a certain existing event (also referred to as a first existing event) in the existing event set exceeds the threshold matching degree, this means that the given event is not a new event. but the existing event. In this case, information related to the target media content may be stored in the entry corresponding to the existing event in the document database 223. The given event is determined from the target media content. In other words, the media content used to extract the given event is stored in the entry corresponding to the existing event as another source of the existing event.

After identifying the additional event, the next step is to update the event evolutionary graph based on the additional event set to achieve incremental update of the event evolutionary graph. Based on the incremental update of the event evolutionary graph, the originally static event evolutionary graph is transformed into a dynamically updatable event evolutionary graph, thereby achieving real-time construction of media contents into the event evolutionary graph.

The event evolutionary graph includes various information, such as events, correlations between different events, and association degrees of correlations. The incremental update of the event evolutionary graph may include one or more kinds of incremental updates of information.

The association degree may indicate to what extent or how likely associated events have the association. For example, causal strength of the causal relationship may indicate how likely the cause event is to cause the effect event. In some embodiments, the association degree may be incrementally updated. To this end, as shown in FIG. 2, the architecture 200 may include the association degree incremental computation module 215, which is configured to use additional events in the additional event set to update the association degrees between events.

The association degree may be computed using any suitable algorithm. In some embodiments, the association degree may be computed based on the occurrence frequency of words (also known as word frequency) and the occurrence frequency of word pairs (also known as co-occurrence frequency) in the text describing the event. The computation of the association degree is described using the causal relationship as an example. For the causal relationship, the association degree may also be referred to as causal strength.

As an example, event A may lead to the occurrence of another event B. Therefore, event A is referred to as the cause event and event B is referred to as the effect event. In a chain of the causal relationship, the causal strength may reflect the probability that the cause event will lead to the occurrence of the effect event. For example, for a causal event pair (A, B), the necessity causal relationship means that the cause event A must exist in order for the effect event B to occur, while the sufficiency causal relationship means that the cause event A is all the conditions that lead to the effect event B. When computing the causal strength, first compute word pair causal strength between word pairs in word i_{c} of the cause event A and word jₑ of the effect event B, and then synthesize the causal strength between the word pairs to obtain the causal strength between the causal events.

The following is an example of computing the causal strength of word pairs and event pairs. Firstly, the causal strength between word pairs (i_{c}, jₑ) may be modeled from the perspectives of necessity and sufficiency.

$$C {S}_{nec} ( {i}_{c} , {j}_{e} ) = \frac{P ( {i}_{c} \vert {j}_{e} )}{{P}^{α} ( {i}_{c} )} = \frac{P ( {i}_{c} , {j}_{e} )}{{P}^{α} ( {i}_{c} ) P ( {j}_{e} )} \qquad ( 1 )$$

$$C {S}_{suf} ( {i}_{c} , {j}_{e} ) = \frac{P ( {j}_{e} \vert {i}_{c} )}{{P}^{α} ( {j}_{e} )} = \frac{P ( {i}_{c} , {j}_{e} )}{{P}^{α} ( {j}_{e} ) P ( {i}_{c} )} \qquad ( 2 )$$

where CS_{nec}(i_{c}, jₑ) modeled the causal strength between i_{c} and jₑ from the perspective of necessity, while CS_{suf}(i_{c}, jₑ) modeled the causal strength between i_{c} and jₑ from the perspective of sufficiency, P(i_{c}|jₑ) represents a posterior probability, a represents a penalty coefficient, and the penalty coefficient may take values between 0 and 1.

Here, probability P(i_{c}) of the occurrence of word i_{c}, the probability P(jₑ) of the occurrence of word jₑ, and the probability P(i_{c}, jₑ) of the simultaneous occurrence of both words i_{c} and jₑ (that is, the occurrence frequency of the word pair) may be computed by the following equation:

$$P ( {i}_{c} ) = \frac{{\sum }_{w ∈ W} f ( {i}_{c} , {w}_{e} )}{M} \qquad ( 3 )$$

$$P ( {j}_{e} ) = \frac{{\sum }_{w ∈ W} f ( {w}_{c} , {j}_{e} )}{M} \qquad ( 4 )$$

$$P ( {i}_{c} , {j}_{e} ) = \frac{f ( {i}_{c} , {j}_{e} )}{N} \qquad ( 5 )$$

where f(i_{c}, jₑ) is the probability of word i_{c} occurring in the cause event and word jₑ occurring in the effect event which is obtained from statistics in the corpus, W is a set of all words that occur in the corpus. M and N are normalization coefficients to ensure that the computed results satisfy the property of probability. The corpus herein may be information related to natural language obtained from various platforms or storage media. For example, the corpus may be a set of media contents for constructing the event evolutionary graph.

It may be concluded that the causal strength CS(i_{c}, jₑ) of the word pair i_{c}, jₑ is computed as follows:

$$C S ( {i}_{c} , {j}_{e} ) = C {{S}_{nec} ( {i}_{c} , {j}_{e} )}^{λ} C {{S}_{suf} ( {i}_{c} , {j}_{e} )}^{1 - λ} \qquad ( 6 )$$

where λ represents a coefficient. Then, the causal strength of the event A and the event B is computed based on the following equation by combining the causal strengths of all word pairs in both the event A and the event B.

$$C {S}_{T} ( A , B ) = \frac{1}{\vert A \vert + \vert B \vert} {\sum }_{i ∈ A} {\sum }_{j ∈ B} C S ( {i}_{c} , {j}_{e} ) \qquad ( 7 )$$

where CS_{T}(A, B) represents the causal strength of the event A and the event B.

The above describes the determination of the association degree using the causal strength as an example. It may be seen that there are many intermediate results in the computation of the association degree, such as frequency information of a cause word, frequency information of a effect word, frequency information of an associated word pair, a necessary causal score of the associated word pair, a sufficient causal score of the associated word pair, and a causal score of the cause and effect word pair. These intermediate results may need to be read and written frequently.

Therefore, in some embodiments, the key-value database 224 may be utilized to store intermediate results of the computation of the association degree. The key-value database 224 may be, for example, a Redis cache database, or other key-value databases. By storing data that needs to be read and written frequently in a database such as a Redis cache database, the efficiency of data reading and writing may be improved, thereby improving the efficiency of constructing the event evolutionary graph. In addition, this also helps to solve the problem of insufficient memory that may exist during the process of constructing the event evolutionary graph.

In such embodiments, the association degree incremental computation module 215 incrementally updates the association degree in the event evolutionary graph. For any additional event (also referred to as the first additional event) in the additional event set, the association degree incremental computation module 215 may determine respective text elements (also referred to as a first text element, such as a word) in the text describing the additional event, and accordingly update element occurrence frequency information corresponding to the text element stored in the key-value database 224. The association degree incremental computation module 215 may further determine an existing event (also referred to as a second existing event) including the text element in the existing event set, that is, the text describing the existing event includes the text element. The association degree incremental computation module 215 further updates, in the event evolutionary graph, an association degree of an event relationship between the existing event and one or more other existing events (also referred to as a third existing event) based on the updated element occurrence frequency information of the text element.

As an example, suppose that an additional event “heavy rain in area A” is determined in the current round of updates, which means that the occurrence frequency of the word “heavy rain” has increased. Correspondingly, the occurrence frequency information of the updated word “heavy rain” in the key-value database will be updated. It is assumed that there is an existing event “heavy rain in area B”, which also includes the word “heavy rain”. Then, the occurrence frequency of the word “heavy rain” has changed, the association degree between the existing event “heavy rain in area B” and other existing events related to it will also be updated.

In some embodiments, the occurrence of the additional event may also cause an update of element pair occurrence frequency information (for example, word pair occurrence frequency information). Correspondingly, the association degree may be further updated based on the updated element pair occurrence frequency information. Specifically, the association degree incremental computation module 215 may determine, from the existing event set or the additional event set, an event (also referred to as a first event or an associated event) having an association with a certain additional event (for example, the first additional event described above) and a text element (also referred to as a second text element) in a text describing the associated event. This means that the occurrence frequency of the element pair composed of the first text element and the second text element increases. Correspondingly, the association degree incremental computation module 215 updates the element pair occurrence frequency information stored in the key-value database 224. The element pair occurrence frequency information indicates that the first text element occurs in association with the second text element, such as the word pair occurrence frequency information. If a text describing the third existing event also comprises the second text element, the association degree between the second existing event and the third existing event may be further updated based on the updated element pair occurrence frequency information.

As an example, it is assumed that the first additional event “heavy rain in area A” is determined in the current round of updates, and the first text element is “heavy rain”. The associated event associated with the first additional event is “flood in area A”, and the second text element in the text of the first event is “flood”. Next, the frequency occurrence information of the element pair “heavy rain”-“flood” needs to be updated. Assuming that the third existing event including “flood” is “flood in area B”, then the association degree between the second existing event “heavy rain in area B” and the third existing event “flood in area B” is further updated based on the occurrence frequency information of the element pair “heavy rain”-“flood”.

In such embodiments, in each round of updates of the event evolutionary graph, only new events are retrieved based on new event tags, and the word frequency and the causal word pair frequency are updated using these new events. At the same time, the key-value database is selected to store the frequency information, and the frequency information of text elements and the frequency information of text element pairs are stored in the key-value database. Efficient reading and writing may be achieved when updating the frequency information, which greatly improves the efficiency of computing the association degree.

The above description is about the incremental computation of the association degree. In some embodiments, the similarity between events may also be computed incrementally. As shown in FIG. 2, the architecture 200 may further include the similarity incremental computation module 216 configured to determine whether an additional event in the additional event set has a similar event. For any additional event (also referred to as a second additional event) in the additional event set, the similarity incremental computation module 216 may determine a similarity between the second additional event and any event (also referred to as a second event) in the additional event set or the existing event set. If the similarity exceeds a threshold similarity, an indication of a similarity relationship between the second additional event and the second event is stored in the document database 223.

If the similarity between the second additional event and the second event exceeds the threshold similarity, it means that the similarity between the second additional event and the second event is relatively high, so the second additional event and the second event may be referred to as a similar event pair. Information about the similar event pair may also be stored in the document database 223. For example, if event 1 has 3 similar events, namely event 2, event 3, and event 4 respectively, the indication of the similarity relationship between these four events, that is, the similarity relationship between the events, may be stored. An example storage format may be {event_id: 1, sim_events: [2,3,4]}, which is used to represent similar events of the event 1, including the event 2, the event 3, and the event 4.

Any suitable similarity computation method may be used in the embodiments of the present disclosure. As an example, Jaccard similarity, Pearson correlation coefficient, Euclidean distance similarity, cosine similarity, etc. may be used. Certainly, other methods may also be used for similarity computation.

In each round of updates of the event evolutionary graph, new events may be determined by identifiers of new events. It is assumed that the number of existing events in the event evolutionary graph is a and the number of new events in this round is b, and the similarity between any two existing events has been computed before this round. In this round of updates, only the similarity between two of the b new events and the similarity between a combination of two events of the existing events and the b new events are needed to be computed. Therefore, the number of similarity computations C_{a+b}² required for this update of the event evolutionary graph may be expressed as C_{a+b}²=C_{b}²+a×b. In contrast, if the event evolutionary graph is not updated incrementally, then additional similarity computations need to be performed between pairwise combinations of the existing events. In this case, the number of similarity computations C′_{a+b}² required to construct the event evolutionary graph may be expressed as C′_{a+b}²+Cₐ²+C_{b}²+a×b. It may be seen that the computation efficiency of constructing the event evolutionary graph using the solution of the present disclosure is higher.

In some embodiments, the similarity computation required for this round of updates to the event evolutionary graph may be employed in an approach of parallel processing using multiple processes or multiple threads, in order to further improve the efficiency of updating the event evolutionary graph.

The event generalization module 217 is configured to perform logical abstraction on events to obtain an abstract event. For example, if an event has two or more similar events, its occurrence may be considered as having generality and can be generalized. It should be understood that an event extracted from media contents is also referred to as a concrete event compared to an abstract event.

The event generalization module 217 may perform generalization based on the results of the event similarity computation. In each round of incremental updates, if an event adds a similar event, the abstract event generalized by the event and its similar events may also be updated. For example, for the second additional event mentioned above and its one or more similar events (also referred to as the second event), the event generalization module 217 may determine an abstract event used for generalizing the second additional event and its similar events. Furthermore, the event generalization module 217 may correspond (for example, map), in the event evolutionary graph, the second additional event and its similar events to the abstract event. The event generalization module 217 may further add a node representing the abstract event to a visual representation of the event evolutionary graph.

As an example without any limitation, an example process of event generalization will be described. For example, firstly perform word segmentation and part-of-speech tagging on the text describing these similar events, and then remove meaningless words based on their part-of-speech. For example, specify words with interjections as meaningless words. Then extract common words from the text and combine them to obtain generalized events. If there is only one common word, determine whether the core word in the text describing the event is an object. If the core word is the common word and the core word is not an object, describe the common word as a generalized event, that is, the common word may be used as the text describing the abstract event. Here, the core word may be a word that may reflect the meaning of part of sentences in the event.

The association degree computation module 218 is configured to compute the association degree between abstract events. The computation of the association degree between abstract events is similar to the computation of the association degree between two events A and B described above, so it will not be repeated here.

In some embodiments, the generalization result obtained by the event generalization module 217, and the result of the association degree of the association degree computation module 218 may be stored in the abstract event pair storage 225.

The event evolutionary graph storage module 219 is configured to store the previously mentioned computation result in the event evolutionary graph storage 226 in a form of nodes, edges, and attributes, to form a visual graph. For example, events may be stored in the event evolutionary graph storage 226 in the form of nodes, the association may be stored in the event evolutionary graph storage 226 in the form of edges, and the association degree may be stored in the event evolutionary graph storage 226 as an attribute of the edge. In some embodiments, the event evolutionary graph storage 226 may be a graph database, such as Neo4j, or other types of graph databases. The embodiments of the present disclosure are not limited in this regard.

The example architecture of the incremental update of the event evolutionary graph is described above with reference to FIG. 2. The event processing flow 300 is described below with reference to a specific example in FIG. 3.

Continuing to refer to FIG. 3, the event extraction module 213 may extract the event 311 and the event 312 with the causal relationship from the media content 301. In this example, the event 311 is a cause event “rise in oil prices”, and the event 312 is an effect event “increase in the cost of road transport business of a company”. The association degree incremental computation module 215 may compute the association degree between the event 311 and the event 312, so that the association degree between the event 311 and the event 312 is 0.25.

The similarity incremental computation module 216 performs event similarity computations on the event 311 and the event 312 respectively. A similar event 321 of the event 311, and a similar event 322 of the event 312 may be determined. In this example, the similar event 321 includes “rise in natural gas prices”, “rise in wheat prices”, or the like, and the similar event 322 includes “increase in living costs”, “increase in the cost of making flour”, or the like.

The event generalization module 217 generalizes the event 311 and its similar event 321 to determine an abstract event 331. The event generalization module 217 generalizes the event 312 and its similar event 322 to determine an abstract event 332. In this example, the abstract event 331 is “rise in prices” and the abstract event 332 is “increase in the cost”.

The association degree computation module 218 computes the association degree between the abstract event 331 and the abstract event 332. Correspondingly, the association degree between the abstract event 331 and the abstract event 332 may be obtained as 0.55. Therefore, the incremental update of the event evolutionary graph is realized. It should be understood that the specific values of events and the association degree described in reference to FIG. 3 are only examples and are not intended to limit the scope of the present disclosure.

The solution of the present disclosure updates the new events to the original event evolutionary graph through incremental updating the event evolutionary graph, which not only achieves efficient incremental construction of the event evolutionary graph, but also realizes real-time update of the event evolutionary graph.

The incremental update solution described above may further be used to construct other types of graphs. In some embodiments, a Knowledge Graph may be incrementally updated, where each node represents an entity. In this case, the embodiments described above relative to “event” may be applied to “entity”. For example, one or more additional entities or new entities that are different from the existing entities in the Knowledge Graph may be determined from the newly obtained or newly extracted entities, and then these new entities may be used to update the Knowledge Graph. In some embodiments, a causal graph may be incrementally updated, where each node represents an element (such as a cause element or a result element). In this case, the embodiments described above relative to “event” may be applied to “element”. For example, one or more additional elements or new elements that are different from the existing elements in the causal graph may be determined from the newly obtained or newly extracted elements, and then the causal graph may be updated with these new elements.

Table 1 shows a comparison between results of using the incremental construction method of the present disclosure and results of not using the incremental construction method. It should be understood that Table 1 uses a causal event evolutionary graph with the causal relationship as an example for explanation.

TABLE 1
A comparison between results of the construction of the event evolutionary graph

| Time | 1 d | 2 d | 3 d | 4 d | 5 d | 6 d | 7 d | 8 d | 9 d | 10 d | 11 d | 12 d |
|---|---|---|---|---|---|---|---|---|---|---|---|---|
| Consistency rate of | 100% | 100% | 100% | 100% | 100% | 100% | 100% | 100% | 100% | 100% | 100% | 100% |
| concrete events | | | | | | | | | | | | |
| Consistency rate of | 100% | 100% | 100% | 100% | 100% | 100% | 100% | 100% | 100% | 100% | 100% | 100% |
| causal event pairs | | | | | | | | | | | | |
| Consistency rate of | 100% | 100% | 100% | 100% | 100% | 100% | 100% | 100% | 100% | 100% | 100% | 100% |
| similar event pairs | | | | | | | | | | | | |
| Consistency rate of | 100% | 100% | 100% | 100% | 100% | 100% | 100% | 100% | 100% | 100% | 100% | 100% |
| abstract events | | | | | | | | | | | | |
| Consistency rate of | 100% | 100% | 100% | 100% | 100% | 100% | 100% | 100% | 100% | 100% | 100% | 100% |
| abstract causal event pairs | | | | | | | | | | | | |
| Consistency rate of mapping | 100% | 100% | 100% | 100% | 100% | 100% | 100% | 100% | 100% | 100% | 100% | 100% |
| relationships of concrete- | | | | | | | | | | | | |
| abstract events | | | | | | | | | | | | |

From Table 1, it can be seen that from the first day (1d) to the twelfth day (12d), a series of indicators for measuring the construction results of the event evolutionary graph indicate consistent construction results, including: the consistency rate of concrete events, the consistency rate of causal event pairs, the consistency rate of similar event pairs, the consistency rate of abstract events, the consistency rate of abstract causal event pairs, and the consistency rate of mapping relationships of concrete-abstract events. It can be seen that the event evolutionary graph constructed using the incremental construction method of this disclosure is completely same as the results produced without the incremental construction method, which indicates that the incremental construction method proposed by this disclosure is correct.

Table 2 shows time consumption of the construction of the event evolutionary graph according to the incremental construction method disclosed herein.

TABLE 2
Statistics on the time consumption of incremental construction
Time consumption after incremental construction is improved

| Time | 1 d | | 2 d | | 3 d | | 4 d | | 5 d | | 6 d | | 7 d | |
|---|---|---|---|---|---|---|---|---|---|---|---|---|---|---|
| Number of media | 21176 | | 20289 | | 20882 | | 21695 | | 28639 | | 5222 | | 4077 | |
| contents | | | | | | | | | | | | | | |
| Data | 21 | min | 19 | min | 19 | min | 19 | min | 22 | min | 5 | min | 5 | min |
| preprocessing | | | | | | | | | | | | | | |
| Event extraction | 16 | min | 14 | min | 15 | min | 15 | min | 18 | min | 4 | min | 4 | min |
| Assigning event | 43 | s | 43 | s | 46 | s | 47 | s | 1 | min | 14 | s | 14 | s |
| ID | | | | | | | | | | | | | | |
| Computation of | 13 | s | 15 | s | 17 | s | 19 | s | 21 | s | 15 | s | 16 | s |
| the causal | | | | | | | | | | | | | | |
| strength | | | | | | | | | | | | | | |
| Computation of | 76 | s | 3 | min | 3 | min | 3 min 46 s | | 4 | min | 1 min 26 s | | 1 min 50 s | |
| event similarities | | | | | | | | | | | | | | |
| Event abstraction | 1 | s | 1 | s | 2 | s | 2 | s | 3 | s | 3 | s | 4 | s |
| Computation of | 1 | s | 1 | s | 1 | s | 1 | s | 1 | s | 1 | s | 1 | s |
| abstract event | | | | | | | | | | | | | | |
| causal strength | | | | | | | | | | | | | | |
| Generation of | 1 | s | 2 | s | 2 | s | 3 | s | 4 | s | 4 | s | 4 | s |
| results | | | | | | | | | | | | | | |
| Total time | 39 | min | 37 | min | 38 | min | 39 | min | 45 | min | 11 | min | 11 | min |

| Time | 8 d | | 9 d | | 10 d | | 11 d | | 12 d | |
|---|---|---|---|---|---|---|---|---|---|---|
| Number of media | 21729 | | 21548 | | 22510 | | 23647 | | 21381 | |
| contents | | | | | | | | | | |
| Data | 19 | min | 19 | min | 19 | min | 20 | min | 18 | min |
| preprocessing | | | | | | | | | | |
| Event extraction | 15 | min | 15 | min | 15 | min | 16 | min | 15 | min |
| Assigning event | 49 | s | 42 | s | 48 | s | 51 | s | 40 | s |
| ID | | | | | | | | | | |
| Computation of | 26 | s | 27 | s | 30 | s | 32 | s | 32 | s |
| the causal | | | | | | | | | | |
| strength | | | | | | | | | | |
| Computation of | 6 | min | 6 | min | 7 | min | 8 | min | 8 | min |
| event similarities | | | | | | | | | | |
| Event abstraction | 4 | s | 4 | s | 5 | s | 5 | s | 6 | s |
| Computation of | 1 | s | 2 | s | 2 | s | 3 | s | 3 | s |
| abstract event | | | | | | | | | | |
| causal strength | | | | | | | | | | |
| Generation of | 4 | s | 5 | s | 7 | s | 7 | s | 8 | s |
| results | | | | | | | | | | |
| Total time | 41 | min | 41 | min | 42 | min | 46 | min | 42 | min |

Table 3 shows time consumption of the construction of the event evolutionary graph without using the incremental construction.

TABLE 3
Statistics on time consumption without the incremental construction
Time consumption before incremental construction is improved

| Time | 1 d | | 2 d | | 3 d | | 4 d | | 5 d | | 6 d | | 7 d | |
|---|---|---|---|---|---|---|---|---|---|---|---|---|---|---|
| Number of | 21176 | | 20289 | | 20882 | | 21695 | | 28639 | | 5222 | | 4077 | |
| media | | | | | | | | | | | | | | |
| contents | | | | | | | | | | | | | | |
| Data | 21 | min | 19 | min | 19 | min | 19 | min | 22 | min | 5 | min | 5 | min |
| preprocessing | | | | | | | | | | | | | | |
| Event | 16 | min | 14 | min | 15 | min | 15 | min | 18 | min | 4 | min | 4 | min |
| extraction | | | | | | | | | | | | | | |
| Assigning | 1 | s | 1 | s | 1 | s | 2 | s | 2 | s | 2 | s | 2 | s |
| event ID | | | | | | | | | | | | | | |
| Computation | 2 | s | 2 | s | 3 | s | 4 | s | 4 | s | 5 | s | 5 | s |
| of the causal | | | | | | | | | | | | | | |
| strength | | | | | | | | | | | | | | |
| Computation | 70 | s | 2.5 | min | 4.5 | min | 8 | min | 11 | min | 12 | min | 13 | min |
| of event | | | | | | | | | | | | | | |
| similarities | | | | | | | | | | | | | | |
| Event | 1 | s | 1 | s | 2 | s | 2 | s | 3 | s | 3 | s | 3 | s |
| abstraction | | | | | | | | | | | | | | |
| Computation | 1 | s | 1 | s | 1 | s | 1 | s | 1 | s | 1 | s | 1 | s |
| of abstract | | | | | | | | | | | | | | |
| event causal | | | | | | | | | | | | | | |
| strength | | | | | | | | | | | | | | |
| Generation of | 1 | s | 1 | s | 2 | s | 2 | s | 3 | s | 3 | s | 3 | s |
| results | | | | | | | | | | | | | | |
| Total time | 38 | min | 36 | min | 39 | min | 42 | min | 51 | min | 21 | min | 23 | min |

| Time | 8 d | | 9 d | | 10 d | | 11 d | | 12 d | |
|---|---|---|---|---|---|---|---|---|---|---|
| Number of | 21729 | | 21548 | | 22510 | | 23647 | | 21381 | |
| media | | | | | | | | | | |
| contents | | | | | | | | | | |
| Data | 19 | min | 19 | min | 19 | min | 20 | min | 18 | min |
| preprocessing | | | | | | | | | | |
| Event | 15 | min | 15 | min | 15 | min | 16 | min | 15 | min |
| extraction | | | | | | | | | | |
| Assigning | 3 | s | 4 | s | 5 | s | 5 | s | 5 | s |
| event ID | | | | | | | | | | |
| Computation | 6 | s | 6 | s | 7 | s | 8 | s | 9 | s |
| of the causal | | | | | | | | | | |
| strength | | | | | | | | | | |
| Computation | 19 | min | 24 | min | 31 | min | 38 | min | 43 | min |
| of event | | | | | | | | | | |
| similarities | | | | | | | | | | |
| Event | 3 | s | 3 | s | 4 | s | 5 | s | 5 | s |
| abstraction | | | | | | | | | | |
| Computation | 1 | s | 1 | s | 1 | s | 1 | s | 1 | s |
| of abstract | | | | | | | | | | |
| event causal | | | | | | | | | | |
| strength | | | | | | | | | | |
| Generation of | 4 | s | 4 | s | 5 | s | 6 | s | 7 | s |
| results | | | | | | | | | | |

| | | | | | | | |
|---|---|---|---|---|---|---|---|
| Total time | 53 | min | 58 | min | 1 h 5 min | 1h 14 min | 1h 16 min |

Tables 2 and Table 3 illustrate the causal event evolutionary graph with the causal relationship as an example. From the comparison of Table 2 and Table 3, it can be seen that the computation of event similarities and the consumed total time can be significantly reduced over time by using the solution of the present disclosure, thereby improving the efficiency of the construction of the event evolutionary graph. It can be seen that after incremental improvement, the efficiency advantage of the incremental construction will become more and more obvious as the scale of the graph expands.

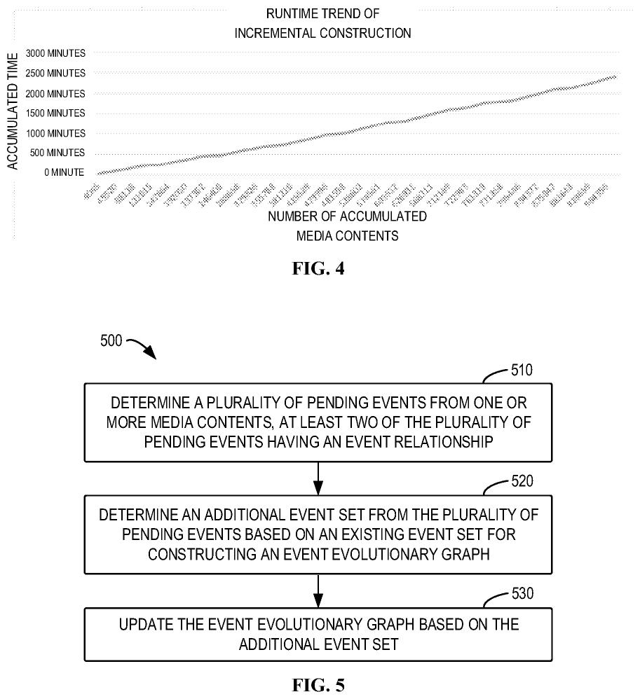

FIG. 4 shows a schematic diagram of runtime of an incrementally constructed evet evolutionary graph according to some embodiments of the present disclosure. As shown in FIG. 4, accumulated time of the construction of the event evolutionary graph changes linearly with a number of accumulated media contents. If the event evolutionary graph is reconstructed for each round of obtaining media contents, the accumulated time of the construction of the event evolutionary graph will increase exponentially with the increase in the number of media contents. It can be seen that by adopting the incremental construction method, the time consumed in updating the event evolutionary graph with the same sample size will not increase with the increase of the existing event evolutionary graph, significantly improving the efficiency of the update of the event evolutionary graph.

### Example Process

FIG. 5 shows a flow chart of a process 500 of information processing according to some embodiments of the present disclosure. The process 500 may be implemented at the electronic device 120.

At block 510, the electronic device 120 determines a plurality of pending events from one or more media contents, at least two of the plurality of pending events having an event relationship.

At block 520, the electronic device 120 determines an additional event set from the plurality of pending events based on an existing event set for constructing an event evolutionary graph. An additional event in the additional event set is different from an existing event in the existing event set.

In some embodiments, in order to determine the additional event set, the electronic device 120 may determine, for a given event of the plurality of pending events, respective matching degrees between a text describing the given event and texts describing respective existing events in the existing event set; and in response to the respective matching degrees being less than a threshold matching degree, identify the given event as an additional event.

In some embodiments, in order to identify the given event as the additional event, the electronic device 120 may add, in a document database for the event evolutionary graph, an entry corresponding to the given event for storing information related to the given event; and set an additional event field in the entry as a predetermined value representing additional events.

In some embodiments, process 500 further comprising: the electronic device 120 in response to the matching degree between the text describing a given event and the text describing the first existing event exceeds a threshold matching degree, the document database and the first existing event corresponding to the entry storing information related to the target media content in one or more media content, a given event is determined from the target media content.

At block 530, the electronic device 120 updates the event evolutionary graph based on the additional event set.

In some embodiments, the process 500 further comprises: the electronic device 120, in response to the update of the event evolutionary graph, canceling the identification of the given event as the additional event.

In some embodiments, in order to update the event evolutionary graph, the electronic device 120 may determine, for a first additional event in the additional event set, a first text element in a text describing the first additional event; update element occurrence frequency information corresponding to the first text element stored in a key-value database; determine a second existing event in the existing event set, wherein a text describing the second existing event comprises the first text element; and update, in the event evolutionary graph, an association degree of an event relationship between the second existing event and a third existing event based on the updated element occurrence frequency information.

In some embodiments, in order to update the association degree, the electronic device 120 determines, from the existing event set or the additional event set, a first event having an event relationship with the first additional event, and a second text element in a text describing the first event; updates element pair occurrence frequency information stored in the key-value database, the element pair occurrence frequency information indicating that the first text element occurs in association with the second text element; and in response to a text describing the third existing event comprising the second text element, updates the association degree further based on the updated element pair occurrence frequency information.

In some embodiments, the process 500 further comprises: the electronic device 120 determines, for a second additional event in the additional event set, a similarity between the second additional event and a second event in the additional event set or the existing event set; and in response to the similarity exceeding a threshold similarity, stores, in a document database for the event evolutionary graph, an indication of a similarity relationship between the second additional event and the second event.

In some embodiments, in order to update the event evolutionary graph, the electronic device 120 may determine an abstract event for generalizing the second additional event and at least the second event having the similarity relationship to the second additional event; correspond, in the event evolutionary graph, the second additional event and the second event to the abstract event; and add a node representing the abstract event to a visual representation of the event evolutionary graph.

### Example Device

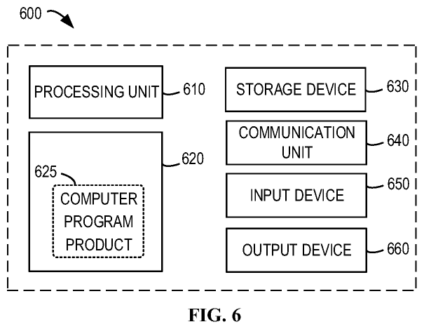

FIG. 6 shows a block diagram of an electronic device 600 in which one or more embodiments of the present disclosure may be implemented. The electronic device 150 of FIG. 1 may be implemented, for example, by the electronic device 600 shown in FIG. 6. It should be understood that the electronic device 600 shown in FIG. 6 is merely an example and should not constitute any limitation on the functionality and scope of the embodiments described herein.

As shown in FIG. 6, the electronic device 600 is in a form of a general purpose computing device. components of the electronic device 600 may include, but are not limited to, one or more processors or a processing unit 610, a memory 620, a storage device 630, one or more communication units 640, one or more input devices 650, and one or more output devices 660. The processing unit 610 may be an actual or virtual processor and is capable of performing various processing according to the program stored in the memory 620. In a multiprocessor system, multiple processing units execute computer-executable instructions in parallel to enhance the parallel processing capability of the electronic device 600.

The electronic device 600 typically includes multiple computer storage mediums. Such mediums may be any available medium accessible to the electronic device 600, including but not limited to a volatile medium and a non-volatile medium, a removable medium and a non-removable medium. The memory 620 may be a volatile memory (such as a register, a cache, a random access memory (RAM)), a non-volatile memory (such as a read-only memory (ROM), an electrically erasable programmable read-only memory (EEPROM), a flash memory), or any combination thereof. The storage device 630 may be a removable medium or a non-removable medium, and may include a machine-readable medium such as a flash drive, a disk, or any other medium that may be used to store information and/or data (such as training data for training) and may be accessed within the electronic device 600.

The electronic device 600 may further include an additional removable/non-removable, volatile/nonvolatile storage medium. although not shown in FIG. 6, a disk drive for reading from or writing into a removable, nonvolatile disk (e.g., “floppy disk”) and an optical disk drive for reading from or writing into a removable, nonvolatile optical disk may be provided. In these cases, each drive may be connected to a bus (not shown) by one or more data medium interfaces. The memory 620 may include a computer program product 625, which has one or more program modules configured to perform various methods or actions of various embodiments disclosed in this disclosure.

The communication unit 640 implements communication with other computing devices through a communication medium. Additionally, the functions of the components of the electronic device 600 may be implemented as a single computing cluster or multiple computing machines, which may communicate through communication connections. Therefore, the electronic device 600 may operate in a networked environment using logical connections with one or more other servers, network personal computers (PCs), or another network node.

An input device 650 may be one or more input devices, such as a mouse, a keyboard, a trackball, etc. The output device 660 may be one or more output devices, such as a display, a speaker, a printer, etc. The electronic device 600 may further communicate with one or more external devices (not shown) through the communication unit 640 as needed, such as a storage device, a displaying device, etc., which communicates with one or more devices that enable users to interact with the electronic device 600, or communicates with any device (such as a network card, a modem, etc.) that enables the electronic device 600 to communicate with one or more other computing devices. Such communication may be performed via an input/output (I/O) interface (not shown).

According to example implementations of the present disclosure, there is provided a computer-readable storage medium having stored thereon a computer executable instruction, where the computer executable instruction is executed by a processor to implement the methods described above. According to example implementations of the present disclosure, there is provided a computer program product, being stored tangibly on a non-transitory computer readable storage medium and comprising a computer executable instruction, where the computer executable instruction is executed by a processor to implement the methods described above.

Various aspects of the present disclosure are described herein with reference to flowcharts and/or block diagrams of methods, apparatus (systems), and computer program products implemented in accordance with the present disclosure. It should be understood that each block of the flowcharts and/or block diagrams and combinations of blocks in the flowcharts and/or block diagrams may be implemented by computer-readable program instructions.

These computer-readable program instructions may be provided to a processing unit of a general-purpose computer, a dedicated computer, or other programmable data processing devices to produce a machine that, when executed by a processing unit of a computer or other programmable data processing devices, produces a device that implements the functions/actions specified in one or more blocks in the flowchart and/or block diagram. These computer-readable program instructions may also be stored in a computer-readable storage medium, which causes a computer, a programmable data processing device, and/or other devices to operate in a specific manner. Therefore, the computer-readable medium storing the instructions includes an article of manufacture that includes instructions for implementing various aspects of the functions/actions specified in one or more blocks in the flowchart and/or block diagram.

The computer-readable program instructions may also be loaded onto a computer, other programmable data processing devices, or other devices to perform a series of operational steps on the computer, other programmable data processing devices, or other devices to produce a computer-implemented process, so that the instructions executed on the computer, other programmable data processing device, or other devices implement the functions/actions specified in one or more blocks in the flowchart and/or block diagram.

The flowcharts and block diagrams in the drawings show a possible architecture, functions, and operations of the systems, methods, and computer program products implemented according to the present disclosure. In this regard, each block in the flowcharts or block diagrams may represent a module, a program segment, or a part of an instruction, which contains one or more executable instructions for implementing the specified logical functions. In some alternative implementations, the functions labeled in the blocks may also occur in a different order than those labeled in the figures. For example, two consecutive blocks may actually be executed in substantially parallel, and they may sometimes be executed in the opposite order, depending on the functions involved. It should also be noted that each block in the diagrams and/or flowcharts, as well as combinations of blocks in the diagrams and/or flowcharts, may be implemented using dedicated hardware-based systems that perform the specified functions or actions, or may be implemented using a combination of dedicated hardware and computer instructions.

The above has described various implementations of the present disclosure. The above description is exemplary, not exhaustive, and is not limited to the various implementations disclosed. Without departing from the scope and spirit of the various implementations described, many modifications and changes are obvious to ordinary technicians in this field. The choice of terms used in this disclosure is intended to best explain the principles, practical applications, or improvements to the technology in the field, or to enable other ordinary technicians in this field to understand the various implementations disclosed in this disclosure.

I/We claim:

1. A method of information processing, comprising:
determining a plurality of pending events from one or more media contents, at least two of the plurality of pending events having an event relationship;
determining an additional event set from the plurality of pending events based on an existing event set for constructing an event evolutionary graph, an additional event in the additional event set being different from an existing event in the existing event set; and
updating the event evolutionary graph based on the additional event set.

2. The method of claim 1, wherein determining the additional event set comprises:
determining, for a given event of the plurality of pending events, respective matching degrees between a text describing the given event and texts describing respective existing events in the existing event set; and
in response to the respective matching degrees being less than a threshold matching degree, identifying the given event as an additional event.

3. The method of claim 2, wherein identifying the given event as the additional event comprises:
adding, in a document database for the event evolutionary graph, an entry corresponding to the given event for storing information related to the given event; and
setting an additional event field in the entry as a predetermined value representing additional events.

4. The method of claim 2, further comprising:
in response to the update of the event evolutionary graph, canceling the identification of the given event as the additional event.

5. The method of claim 3, further comprising:
in response to the matching degree between the text describing the given event and a text describing a first existing event exceeding the threshold matching degree, storing, in an entry in the document database corresponding to the first existing event, information related to a target media content in the one or more media contents, wherein the given event is determined from the target media content.

6. The method of claim 1, wherein updating the event evolutionary graph comprises:
determining, for a first additional event in the additional event set, a first text element in a text describing the first additional event;
updating element occurrence frequency information corresponding to the first text element stored in a key-value database;
determining a second existing event in the existing event set, wherein a text describing the second existing event comprises the first text element; and
updating, in the event evolutionary graph, an association degree of an event relationship between the second existing event and a third existing event based on the updated element occurrence frequency information.

7. The method of claim 6, wherein updating the association degree comprises:
determining, from the existing event set or the additional event set, a first event having an event relationship with the first additional event, and a second text element in a text describing the first event;
updating element pair occurrence frequency information stored in the key-value database, the element pair occurrence frequency information indicating that the first text element occurs in association with the second text element; and
in response to a text describing the third existing event comprising the second text element, updating the association degree further based on the updated element pair occurrence frequency information.

8. The method of claim 1, further comprising:
determining, for a second additional event in the additional event set, a similarity between the second additional event and a second event in the additional event set or the existing event set; and
in response to the similarity exceeding a threshold similarity, storing, in a document database for the event evolutionary graph, an indication of a similarity relationship between the second additional event and the second event.

9. The method of claim 8, wherein updating the event evolutionary graph comprises:
determining an abstract event for generalizing the second additional event and at least the second event having the similarity relationship to the second additional event;
corresponding, in the event evolutionary graph, the second additional event and the second event to the abstract event; and
adding a node representing the abstract event to a visual representation of the event evolutionary graph.

10. An electronic device, comprising:
at least one processing circuit, wherein the at least one processing circuit is configured to perform a method of information processing, the method comprising:
determining a plurality of pending events from one or more media contents, at least two of the plurality of pending events having an event relationship;
determining an additional event set from the plurality of pending events based on an existing event set for constructing an event evolutionary graph, an additional event in the additional event set being different from an existing event in the existing event set; and
updating the event evolutionary graph based on the additional event set.

11. The device of claim 10, wherein determining the additional event set comprises:
determining, for a given event of the plurality of pending events, respective matching degrees between a text describing the given event and texts describing respective existing events in the existing event set; and
in response to the respective matching degrees being less than a threshold matching degree, identifying the given event as an additional event.

12. The device of claim 11, wherein identifying the given event as the additional event comprises:
adding, in a document database for the event evolutionary graph, an entry corresponding to the given event for storing information related to the given event; and
setting an additional event field in the entry as a predetermined value representing additional events.

13. The device of claim 11, further comprising:
in response to the update of the event evolutionary graph, canceling the identification of the given event as the additional event.

14. The device of claim 12, further comprising:
in response to the matching degree between the text describing the given event and a text describing a first existing event exceeding the threshold matching degree, storing, in an entry in the document database corresponding to the first existing event, information related to a target media content in the one or more media contents, wherein the given event is determined from the target media content.

15. The device of claim 10, wherein updating the event evolutionary graph comprises:
determining, for a first additional event in the additional event set, a first text element in a text describing the first additional event;
updating element occurrence frequency information corresponding to the first text element stored in a key-value database;
determining a second existing event in the existing event set, wherein a text describing the second existing event comprises the first text element; and
updating, in the event evolutionary graph, an association degree of an event relationship between the second existing event and a third existing event based on the updated element occurrence frequency information.

16. The device of claim 15, wherein updating the association degree comprises:
determining, from the existing event set or the additional event set, a first event having an event relationship with the first additional event, and a second text element in a text describing the first event;
updating element pair occurrence frequency information stored in the key-value database, the element pair occurrence frequency information indicating that the first text element occurs in association with the second text element; and
in response to a text describing the third existing event comprising the second text element, updating the association degree further based on the updated element pair occurrence frequency information.

17. The device of claim 10, further comprising:
determining, for a second additional event in the additional event set, a similarity between the second additional event and a second event in the additional event set or the existing event set; and
in response to the similarity exceeding a threshold similarity, storing, in a document database for the event evolutionary graph, an indication of a similarity relationship between the second additional event and the second event.

18. The device of claim 17, wherein updating the event evolutionary graph comprises:
determining an abstract event for generalizing the second additional event and at least the second event having the similarity relationship to the second additional event;
corresponding, in the event evolutionary graph, the second additional event and the second event to the abstract event; and
adding a node representing the abstract event to a visual representation of the event evolutionary graph.

19. A non-transitory computer readable storage medium having a computer program stored thereon, wherein the program, when executed by a processor, performs a method of information processing, the method comprising:
determining a plurality of pending events from one or more media contents, at least two of the plurality of pending events having an event relationship;
determining an additional event set from the plurality of pending events based on an existing event set for constructing an event evolutionary graph, an additional event in the additional event set being different from an existing event in the existing event set; and
updating the event evolutionary graph based on the additional event set.
